(19) United States
(12) Patent Application Publication
(10) Pub. No.: US 2008/0270126 A1
(43) Pub. Date: Oct. 30, 2008

(54) Apparatus for Vocal-Cord Signal Recognition and Method Thereof

(75) Inventors: Young-Giu Jung, Daejon (KR); Mun-Sung Han, Daejon (KR); Kwan-Hyun Cho, Daejon (KR); Jun-Seok Park, Daejon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/091,267

(22) PCT Filed: Oct. 19, 2006
(86) PCT No.: PCT/KR2006/004261

§ 371 Date: Apr. 23, 2008

(30) Foreign Application Priority Data
Oct. 28, 2005 (KR) 10-2005-0102431

(51) Int. Cl. G10L 21/00

(52) U.S. Cl. 704/222; 704/E21.001

(57) ABSTRACT

Provided are a vocal-cord recognition apparatus and a method thereof. The vocal-cord signal recognition apparatus includes a vocal-cord signal extracting unit for analyzing a feature of a vocal-cord signal inputted through a throat microphone, and extracting a vocal-cord feature vector from the vocal-cord signal using the analyzing data; and a vocal-cord signal recognition unit for recognizing the vocal-cord signal by extracting the feature of the vocal-cord signal using the vocal-cord signal feature vector extracted at the vocal-cord signal extracting means.

### TECHNICAL FIELD

The present invention relates to an apparatus for vocal-cord signal recognition and a method thereof; and more particularly, to a vocal-cord signal recognition apparatus for accurately recognizing a vocal-cord signal by extracting a vocal-cord signal feature vector from the vocal-cord signal and recognizing the vocal-cord signal based on the extracted feature vector, and a method thereof.

### BACKGROUND ART

FIG. 1 is a block diagram illustrating a conventional speech recognition apparatus. As shown in FIG. 1, the speech recognition apparatus includes an end-point detecting unit 101, a feature extracting unit 102 and voice recognition unit 103.

The end-point detecting unit 101 detects an end-point of a voice signal inputted through a standard microphone and transfers the detected end-point to the feature extracting unit 102.

The feature extracting unit 102 extracts features that can accurately express the features of the voice signal transferred from the end-point detector 101, and transfers the extracted feature to the voice recognition unit 103. The feature extracting unit 102 generally uses a mel-frequency cepstrum coefficient (MFCC), a linear prediction co-efficient cepstrum (LPCC), or a perceptually-based linear prediction cepstrum co-efficient (PLPCC) to extract the feature from the voice signal.

The voice recognition unit 103 calculates a recognition result by measuring a likelihood using the extracted feature from the feature extracting unit 102. In order to calculate the recognition result, the voice recognition unit 103 mainly uses a hidden markow model (HMM), a dynamic time warping (DTW), and a neural network.

However, the voice recognition apparatus according to the related art cannot accurately recognize a user's command in a heavy noise environment such as a factory, the inside of a vehicle, and a war. Therefore, the recognition rate thereof becomes degraded in the heavy noise environment. That is, the conventional voice recognition apparatus cannot be used in the heavy noise environment.

Therefore, there is a demand for a voice recognition apparatus capable of accurately recognizing a user's command even in the heavy noise environment such as a factory, the inside of a vehicle, and a battle field.

### DISCLOSURE OF INVENTION

### Technical Problem

It is, therefore, an object of the present invention to provide a vocal-cord signal recognition apparatus which extracts feature vectors with a higher recognition for the vocal-cord signal rate and accurately recognizing a vocal-cord signal using the extracted feature vectors for the vocal-cord signal, and a method thereof.

It is another object of the present invention to provide a vocal-cord signal recognition apparatus which extracts a vocal-cord signal feature vector using a feature extracting algorithm that guarantees a high recognition rate, accurately recognizes a vocal-cord signal such as a user's command, and controls various equipments according to the recognition result, and a method thereof.

### Technical Solution

In accordance with one aspect of the present invention, there is provided a vocal-cord recognition apparatus including: a vocal-cord signal extracting unit for analyzing a feature of a vocal-cord signal inputted through a throat microphone, and extracting a vocal-cord feature vector from the vocal-cord signal using the analyzing data; and a vocal-cord signal recognition unit for recognizing the vocal-cord signal by extracting the feature of the vocal-cord signal using the vocal-cord signal feature vector extracted at the vocal-cord signal extracting means.

In accordance with another aspect of the present invention, there is provided a vocal-cord signal recognition method including the steps of: a) creating and storing feature vector candidates of a vocal-cord signal using a phonological feature; b) digitalizing a vocal-cord signal inputted from a throat microphone; c) analyzing the digitalized vocal-cord signal according to frequencies; d) selecting a feature vector of the vocal-cord signal among the created feature vector candidates using the analyzed features of the vocal-cord signal; e) detecting an end-point of the digitalized vocal-cord signal which is a user's command; f) extracting the feature of the vocal-cord signal for the detected region where the end-point detected using the selected vocal-cord signal feature vector; and g) recognizing the vocal-cord signal by measuring a likelihood using the extracted feature of the vocal-cord.

### Advantageous Effects

A vocal-cord recognition apparatus and method in accordance with the present invention extracts a vocal-cord signal feature vector using a feature extracting algorithm that guarantees a higher recognition rate and accurately recognizes the vocal-cord signal that is the user's command based on the extracted vocal-cord signal feature vector. Therefore, the recognition rate of a vocal-cord signal can be improved. Furthermore, the vocal-cord recognition apparatus and method thereof in accordance with the present invention can accurately recognize the user's command which is a vocal-cord signal with a high recognition rate in a heavy noise environment such as a factory, the inside of a vehicle, and the war. Therefore, various devices can be controlled according to the recognition result in the heavy noise environment.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a voice recognition apparatus in accordance with a related art;

FIG. 2 is a block diagram illustrating a vocal-cord signal recognition apparatus in accordance with an embodiment of the present invention;

FIG. 3 is a block diagram illustrating a vocal-cord signal recognition apparatus in accordance with an embodiment of the present invention;

FIGS. 4 and 5 are graphs showing a difference between a vocal-cord signal and a voice signal; and

FIGS. 6 and 7 show energy variation in frequency domains of each frame of a vocal-cord signal and a voice signal.

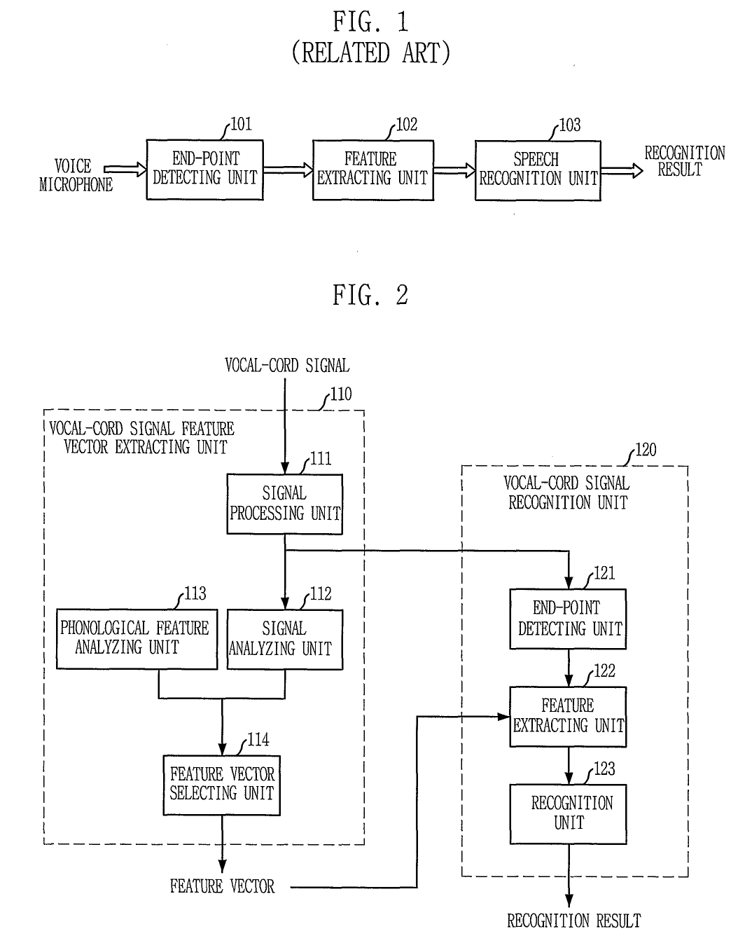

### BEST MODE FOR CARRYING OUT THE INVENTION

Other objects and aspects of the invention will become apparent from the following description of the embodiments with reference to the accompanying drawings, which is set forth hereinafter.

FIG. 2 is a block diagram illustrating a vocal-cord signal recognition apparatus in accordance with an embodiment of the present invention.

As shown in FIG. 2, the vocal-cord signal recognition apparatus according to the present embodiment includes a vocal-cord signal feature extracting unit 110, and a vocal-cord signal recognition unit 120. The vocal-cord signal feature extracting unit 110 analyzes the features of a vocal-cord signal, which is a user's command, inputted through a throat microphone, and extracts a vocal-cord feature vector from the vocal-cord signal using the analyzing data. The vocal-cord signal recognition unit 120 extracts the feature of the vocal-cord signal using the extracted vocal-cord feature vector, and recognizes the vocal-cord signal using the extracted feature.

The vocal-cord feature vector extracting unit 110 includes a signal processing unit 111, a signal analyzing unit 112, a phonological feature analyzing unit 113 and a feature vector selecting unit 114. The signal processing unit 111 digitalizes the vocal-cord signal inputted from the throat microphone. The signal analyzing unit 112 receives the vocal-cord signal from the signal processing unit 111, and analyzes the features of the vocal-cord signal according to a frequency. The phonological feature analyzing unit 113 generates the feature vector candidates of the vocal-cord signal using the phonological feature. The feature vector selecting unit 114 selects a feature vector suitable to the vocal-cord signal among the feature vector candidates of the phonological feature analyzing unit 113 using the analyzing data of the signal analyzing unit 112.

The vocal-cord signal recognition unit 120 includes an end-point detecting unit 121, a feature extracting unit 122 and a recognition unit 123. The end-point detecting unit 121 detects an end-point of an input vocal-cord signal, which is a user's command. The feature extracting unit 122 extracts the feature of the vocal-cord signal form the detected region at the end-point detecting unit 121 using the selected feature vector at the feature vector selecting unit 114. The recognition unit 123 recognizes the vocal-cord signal by measuring a likelihood using the extracted feature from the feature extracting unit 122.

Hereinafter, each of the constitutional elements of the vocal-cord recognition apparatus and the method according to the present embodiment will be described in more detail.

At first, the signal processing unit 111 digitalizes the vocal-cord signal which is a user's command inputted through a throat microphone, and outputs the digitalized vocal-cord signal to the signal analyzing unit 112 and the end-point detecting unit 121.

The signal processing unit 111 may include a single signal processor as described above, or the signal processing unit 111 may include a first signal processor for digitalizing the vocal-cord signal that is the user's command inputted through the external vocal-cord signal and outputting the digitalized vocal-cord signal to the signal analyzing unit 112, and a second signal processor for digitalizing the same vocal-cord signal that is the user's command inputted through the external vocal-cord signal and outputting the digitalized vocal-cord signal to the end-point detecting unit 121.

The throat microphone is a microphone for obtaining the vocal-cord signal from the user's vocal-cord, and the throat microphone is embodied by using a neck microphone capable of obtaining the vibration signal of the vocal-cord.

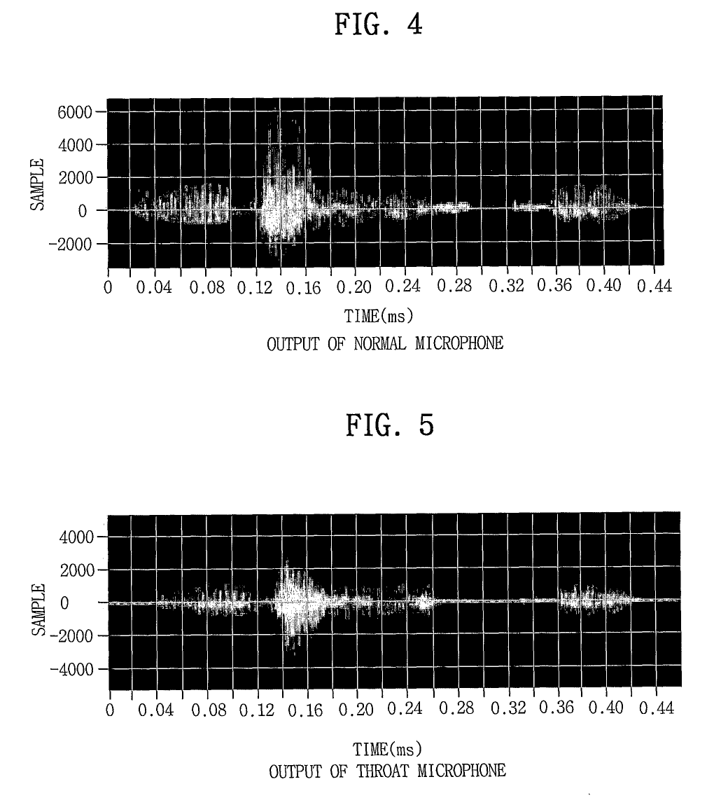

The signal analyzing unit 112 receives the vocal-cord signal from the signal processing unit 111, analyzes the received vocal-cord signal, and outputs the analyzing result to the feature vector selecting unit 114. A step for analyzing features according to the frequencies of a vocal-cord will be described with reference FIGS. 4 through 7.

FIGS. 4 and 5 are graphs showing a difference between a vocal-cord signal and a voice signal. FIG. 5 is graph showing the vocal-cord signal inputted through the throat microphone, and FIG. 4 is a graph showing the voice signal input through the standard microphone. As shown in FIGS. 4 and 5, the vocal-cord signal and the voice signal have a similar form although the amplitude thereof is different.

If the recognition rates of the vocal-cord signal and the voice signal are measured after collecting voice data from 100 persons through the throat microphone and the standard microphone and extracting features thereof using a MFCC algorithm which is the most widely used method for extracting feature, the recognition rate of the vocal-cord signal is about 40% lower than that of the voice signal.

The differences between the vocal-cord signal collected from the throat microphone and the voice signal collected from the standard microphone is analyzed as follows.

At first, the vocal-cord signal has the limited frequency information. It is because the high frequency data is generated through the tongue and a vibration inside the mouth. Therefore, the vocal-cord signal collected through the throat microphone seldom includes the high frequency information. Also, the throat microphone is developed to filter a high frequency signal higher than about 4 KHz.

Secondly, the vocal-cord signal collected through the throat microphone includes very few formants compared to the voice signal collected through the voice microphone. That is, a formant discriminating ability is significantly lower in the vocal-cord signal. Such a low formant discriminating ability causes a voice discriminating ability to be degraded. Therefore, it is not easy to recognize a vowel in the vocal-cord signal.

Herein, the formant denotes a voice frequency intensity distribution. Each of general voiced sounds has a unique frequency distribution form which can be obtained from the sound wave of the voiced sound using a frequency detecting and analyzing device. If the voiced sound is the vowel, the frequency distribution form thereof is consisted of basic frequencies about 75 to 300 Hz, which represent the number of vibration of the vocal-cord for one second, and high frequencies which are integer time higher than the basic frequencies. Among the high frequencies, some are emphasized, in general, three high frequencies. Such emphasized high frequencies are defined as a first, a second and a third formant from the lowest frequency. Since there is a personal difference according to the size of the mouth, three formants may be defined to be slightly strengthened or weakened according to the individual. It is a reason why an individual has a unique voice tone.

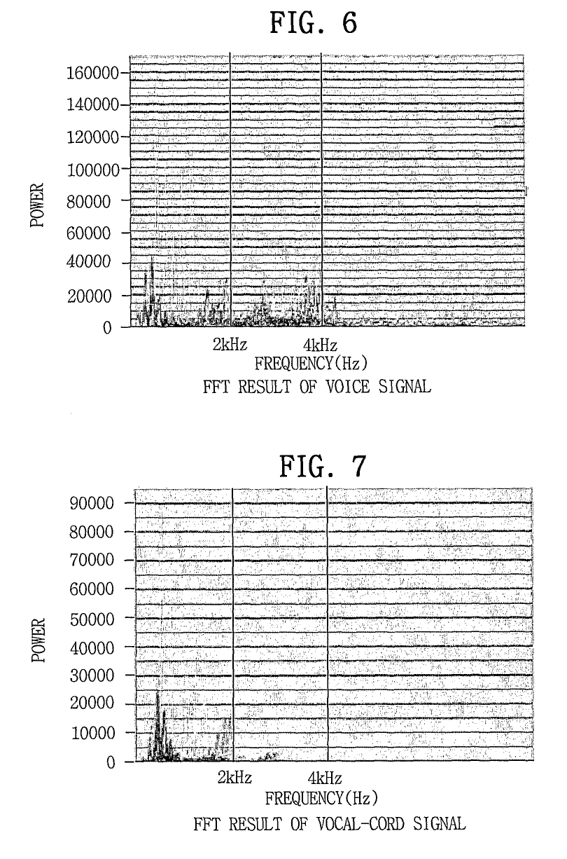

FIGS. 6 and 7 show energy variation in frequency domains of each frame of a vocal-cord signal and a voice signal.

With reference to FIGS. 6 and 7, the difference of the voice signal and the vocal-cord signal according to a feature extracting algorithm will be described through a spectrum analysis. That is, the information amounts of the voice signal and the vocal-cord signal are compared and analyzed after performing a Fast Fourier Transform (FTT) using a MFCC algorithm which is the most widely used feature extracting algorithm. FIGS. 6 and 7 show a result of performing the Fast Fourier Transform (FFT) on 16k 16-bit wave data after applying a pre-emphasis and a hamming window to the wave data. In FIGS. 6 and 7, a horizontal axis denotes indices of the frequency region divided by 256, and a vertical axis denotes energy values included in the frequency domain. Various colors in graphs denote each frame. As shown in FIGS. 6 and 7, similar energy distributions are shown at a frequency domain below about 2 KHz in two graphs. However, the vocal-cord signal includes very small amount of information in a frequency domain between about 2 kHz to 4 kHz compared to the voice signal. Furthermore, the vocal-cord signal seldom includes high frequency information at a frequency domain higher than 4 kHz. Therefore, the feature of the voice cord signal cannot be modeled using the MFCC algorithm that uses the energy information in the frequency domain. Also, the general feature extracting algorithm using the high frequency information cannot be used for accurately modeling the vocal-cord signal.

The phonological feature analyzing unit 113 creates feature vector candidates of the vocal-cord signal using the phonological feature. That is, the phonological feature analyzing unit 113 is a module that creates the candidates of the feature vectors suitable for the vocal-cord signal using the phonological feature of the language. For example, the Korean is a phoneme letter composed of a vowel and a consonant. A word is formed by combining the vowel and consonant in a syllable. The Korean includes 21 vowels each having a voiced sound feature. The Korean includes 19 consonants which may have a voiced sound feature or a voiceless sound feature according to the shape and the position. Table 1 show the classification of the Korean consonants.

TABLE 1

| | | Sound from front tongue | | | | |
|---|---|---|---|---|---|---|
| | | | | Sound | | |
| Class- | Sound | Sound | Sound | made by | Sound | Sound |
| ifica- | from | made by | made by | fricitioni- | from | from |
| tion | both | stopping | affricating | zing | rear | rear |
| factor | lips | tongue | tongue | tongue | tongue | head |
| plane | [symbol] | [symbol] | [symbol] | [symbol] | [symbol] | |
| sound | | | | | | |
| fortis | [symbol] | [symbol] | [symbol] | [symbol] | [symbol] | |
| sound | | | | | | |
| Aspira- | [symbol] | [symbol] | [symbol] | | [symbol] | [symbol] |
| tion | | | | | | |
| sound | | | | | | |
| Nasal | [symbol] | | [symbol] | | [symbol] | |
| sound | | | | | | |
| Liquid | | | [symbol] | | | |
| sound | | | | | | |

A Korean syllable is composed by combining a consonant+a vowel+a consonant, a vowel+a consonant, or a consonant+a vowel or vowels. The Korean syllable itself has a phonological feature or would have the phonological feature when it is sounded. The phonological feature denotes a unique feature having a phoneme. The phonological feature is classified into a voiced feature, a vocalic and a consonantal feature, a syllabic feature, a sonorant feature and an obstruent feature. Hereinafter, each of the phonological features will be described, briefly.

The voiced feature denotes the discrimination of a voiced sound and a voiceless sound. The voiced feature relates a feature denting whether the vocal cord is vibrated or not.

The vocalic and the consonantal feature is a feature to discriminate a vowel and a voiced sound. All vowels have the vocalic feature without the consonantal feature. The voiced sounds have both of the vocalic and consonantal features. The consonants have the consonantal feature without the vocalic feature.

The syllabic feature is a representative feature of a vowel. It is the feature of a segment.

The sonorant and the obstruent feature denote levels of propagating a sound made from the same size of the mouth.

The phonological features are closely related to the vocal-cord system. In the present invention, the feature of the vocal-cord signal is modeled using the phonological features related to the vibration of the vocal-cord such as the voiced feature, the vocalic and the consonantal feature. In Table 1, a nasal sound and a liquid sound are belonged to the voiced sound, and others are belonged to the voiceless sound. However, the voiceless sound such as ‘□, □, □, □, □’ excepting “□” may have the feature of the voiced sound due to the vocalization occurred when the voiceless sounds are interleaved between the voiced sounds. In case of the Korean, all words include the voiced sound such as the vowel, and voiced sound consonants are more frequently shown in the words compared to the vowels due to the voiced consonants or the vocalization. Such phonological features are the voiced feature, and the vocalic and the consonantal feature, and the vocal-cord signal feature can be modeled through these phonological features.

The feature vector selecting unit 114 is a module selecting a feature vector suitable to a vocal-cord signal using the result of the phonological feature analyzing unit 113 and the signal analyzing unit 112. That is, the feature vector selecting unit 114 selects a feature vector suitable to the vocal-cord signal among the feature vector candidates of the phonological feature analyzing unit 113 using the analyzing data from the signal analyzing unit 112. A general feature extracting algorithm using the high frequency information as the feature vector is not suitable for automatically recognizing the vocal-cord signal that includes very small amount of high frequency information. A feature vector that can accurately discriminate a voiced sound only is more suitable to the vocal-cord signal. Therefore, a feature vector suitable to the vocal-cord signal is energy, pitch cycle, zero-crossing, zero-crossing rate and peak.

Therefore, a high recognition rate can be provided when an auto vocal-cord signal recognition apparatus is embodied to use a feature extracting algorithm that uses energy, pitch cycle, zero-crossing, zero-crossing rate, peak, and peak or energy value in zero-crossing as the feature vectors for the vocal-cord signal.

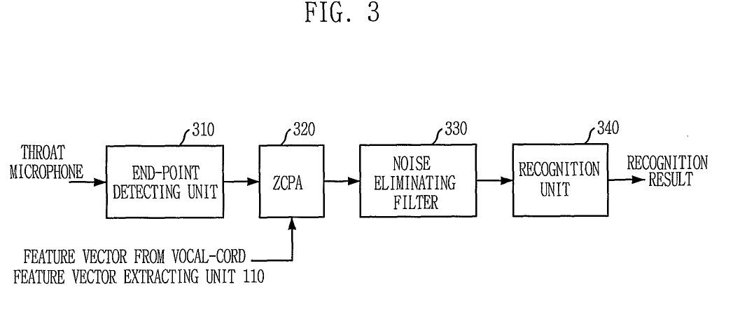

AS the auto vocal-cord signal recognition apparatus using the feature extracting algorithm with the vocal-cord signal suitable feature vector, an automatic vocal-cord signal recognition apparatus using feature vectors of a zero crossings with peak amplitudes (ZCPA) is introduced in the present invention as shown in FIG. 3. The ZCPA is a feature extracting algorithm modeling the vocal-cord signal using a zero crossing, and a peak in the zero crossing. Such an automatic vocal-cord signal recognition apparatus is embodied by including the vocal-cord signal feature vector extracting unit 110 of FIG. 2, or using the output result which is the extracted feature vector from the vocal-cord signal feature vector extracting unit 110 of FIG. 2. Also, the automatic vocal-cord signal recognition apparatus may further include the noise removing filter 303 for removing the channel noise.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean patent application No. 2005-0102431, filed with the Korean Intellectual Property Office on Oct. 28, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A vocal-cord recognition apparatus, comprising:
a vocal-cord signal extracting means for analyzing a feature of a vocal-cord signal inputted through a throat microphone, and extracting a vocal-cord feature vector from the vocal-cord signal based on the analyzing data; and
a vocal-cord signal recognition means for recognizing the vocal-cord signal by extracting the feature of the vocal-cord signal based on the vocal-cord signal feature vector extracted at the vocal-cord signal extracting means.

2. The vocal-cord recognition apparatus as recited in claim 1, wherein the vocal-cord signal feature extracting unit includes:
a signal processing unit for digitalizing a vocal-cord signal inputted from the throat microphone;
a signal analyzing unit for analyzing features of the vocal-cord signal inputted from the signal processing unit according to frequencies;
a phonological feature analyzing unit for creating feature vector candidates of the vocal-cord signal based on a phonological feature; and
a feature vector selecting unit for selecting a feature vector of the vocal-cord signal among the feature vector candidates created from the phonological feature analyzing unit based on the analyzing data of the signal analyzing unit.

3. The vocal-cord recognition apparatus as recited in claim 2, wherein the vocal-cord signal recognition means includes:
an end-point detecting unit for detecting an end-point of a vocal-cord signal that is a user's command inputted from the signal processing unit;
a feature extracting unit for extracting a feature of the vocal-cord signal using the selected feature vector at the feature vector selecting unit for the detected region of the end-point detecting unit; and
a recognition unit for recognizing the vocal-cord signal by measuring a likelihood based on the feature extracted from the feature extracting unit.

4. The vocal-cord recognition apparatus as recited in claim 2, wherein the signal analyzing unit performs a Fast Fourier Transform (FFT) using spectrum and a Mel-frequency cepstrum coefficient (MFCC), and analyzes the features of the vocal-cord signal at each frequency based on the FFT result.

5. The vocal-cord recognition apparatus as recited in claim 2, wherein the phonological feature analyzing unit creates feature vector candidates of a vocal-cord signal using phonological features related to vibration of a vocal cord, where the phonological features include a voiced feature, a vocalic feature and a consonantal feature.

6. The vocal-cord recognition apparatus as recited in claim 2, wherein the feature vector selecting unit uses energy, pitch period, zero-crossing, zero-crossing rate, peak, and a peak or energy value in zero-crossing to select the feature vector.

7. The vocal-cord signal recognition apparatus as recited in claim 2, wherein the vocal-cord signal recognition apparatus uses a zero-crossings with a peak amplitudes (ZCPA) algorithm that models a vocal-cord using zero-crossing and peak of zero-crossing.

8. A vocal-cord signal recognition method, comprising the steps of:
a) creating and storing feature vector candidates of a vocal-cord signal using a phonological feature;
b) digitalizing a vocal-cord signal inputted from a throat microphone;
c) analyzing the digitalized vocal-cord signal according to frequencies;
d) selecting a feature vector of the vocal-cord signal among the created feature vector candidates using the analyzed features of the vocal-cord signal;
e) detecting an end-point of the digitalized vocal-cord signal which is a user's command;
f) extracting the feature of the vocal-cord signal for the detected region where the end-point detected using the selected vocal-cord signal feature vector; and
g) recognizing the vocal-cord signal by measuring a likelihood using the extracted feature of the vocal-cord.
